(19) United States
(12) Patent Application Publication
(10) Pub. No.: US 2013/0154967 A1
(43) Pub. Date: Jun. 20, 2013

(54) ELECTRONIC DEVICE AND TOUCH CONTROL METHOD THEREOF

(71) Applicants: Hung-Yi Lin, Taipei City (TW); Jung-Hsing Wang, Taipei City (TW)

(72) Inventors: Hung-Yi Lin, Taipei City (TW); Jung-Hsing Wang, Taipei City (TW)

(21) Appl. No.: 13/688,225

(22) Filed: Nov. 29, 2012

(30) Foreign Application Priority Data
Dec. 14, 2011 (TW) 100146280

(51) Int. Cl. G06F 3/041

(52) U.S. Cl. CPC G06F 3/041
USPC 345/173

(57) ABSTRACT

A touch control method is adapted for an electronic device. The electronic device includes a touch pad and a control processor. The control processor is electronically connected to the touch pad and has a reference value. First, producing a touch a first pressure at the touch pad, and then generating a click signal when the touch on the touch pad is increased from a first pressure to a second pressure and the increase value of the second pressure is larger than the reference value.

### CROSS-REFERENCE TO RELATED APPLICATION

This application claims the priority benefit of Taiwan application serial No. 100,146,280, filed on Dec. 14, 2011. The entirety of the above-mentioned patent application is hereby incorporated by reference herein and made a part of specification.

### BACKGROUND OF THE INVENTION

1. Field of the Invention

The invention relates to a touch pad and, more particularly, relates to a touch pad of an electronic device and a touch control method thereof.

2. Description of the Related Art

As electronic technology is developed rapidly along with its widespread use, electronic devices become necessary in various domains, people use kinds of input devices such as a keyboard, a mouse, a touch pad or a track ball to input data or operate the electronic device. Due to small size and convenience in operation, the touch pad is widely integrated to electronic devices such as a notebook, a PDA, and a mobile phone.

Mechanical keys are usually disposed at a side of a conventional touch pad to simulate the function of the mouse. When a user press the mechanical key, a signal like that generated by clicking the left or right key of the mouse is transmitted.

### BRIEF SUMMARY OF THE INVENTION

An electronic device includes a touch pad and a control processor. The touch pad is used for receiving a touch. The control processor is electronically connected to the touch pad and has a reference value. When the touch on the touch pad is increased from a first pressure to a second pressure, if the control processor determines the increase value of the second pressure is larger than the reference value, the control processor generates a click signal.

In an embodiment, the control processor has a reference time, when the duration of the second pressure is longer than the reference time, the control processor generates the click signal.

In an embodiment, when the first pressure is applied on the touch pad, the control processor generates a control signal.

A touch control method adapted for an electronic device is further provided. The electronic device includes a touch pad and a control processor. The touch pad is used for receiving a touch. The control processor is electronically connected to the touch pad and has a reference value. First, producing a touch a first pressure at the touch pad, and then generating a click signal when the touch on the touch pad is increased from a first pressure to a second pressure and the increase value of the second pressure is larger than the reference value.

In an embodiment, the touch control method further includes determining that the duration of the second pressure is longer than the reference time set at the control processor before the step of generating the click signal.

In an embodiment, the control processor generates a control signal when the first pressure is applied at the touch pad.

Consequently, the electronic device and the touch control method can determine whether the touch is an effective click action so as generate a click signal according to the change of the pressure at the touch pad.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic device according to an embodiment of the invention;

FIG. 2 is a schematic diagram showing the influence on the detecting circuit due to the touch on the touch pad in FIG. 1; and

FIG. 3 is a flowchart showing a touch control method according to an embodiment of the invention.

### DETAILED DESCRIPTION OF THE EMBODIMENTS

An electronic device determines whether to generate a click signal according to the variousness of pressure received at a touch pad. When the touch pressure is increased, the induction area of the touch pad touched by a finger is increased, and thus the induction value of the capacitor is changed. Consequently, the pressure of a finger is used for controlling an input command. When the touch pressure is increased from a first pressure to a second pressure, whether the touch is an effective click action is determined according to whether increased induction area (or the change of the capacitance) is larger than a reference value due to the touch pressure so as to generate a click signal, instead of a press signal generated by pressing a conventional mechanical key, and it also can identify the mouse moving action and a dragging action.

A notebook is taken as an example, which is not limited herein as long as an electronic device has a touch pad. The touch pad has a function of displaying and inducing the position of a cursor of the electronic device, executing commands, and displaying menus and so on. When the touch pad is touched, the signal is transmitted to a control processor of the notebook to determine, and then the control processor controls and converts it to relating corresponding commands.

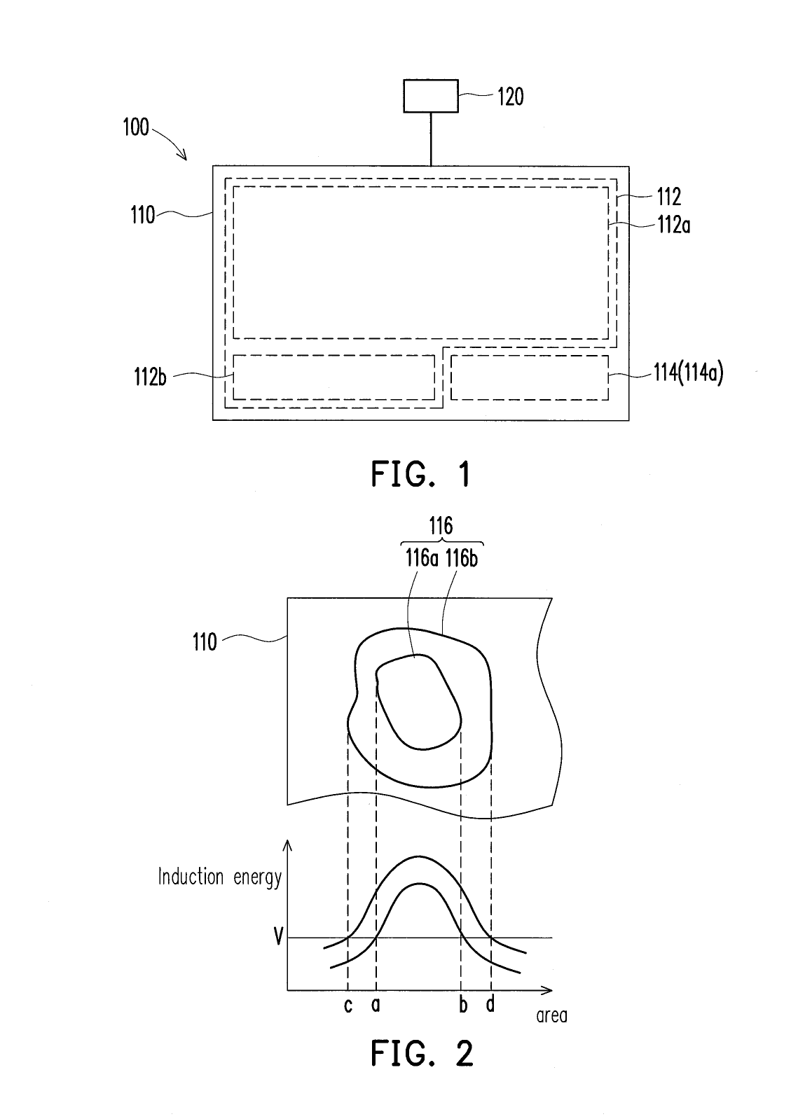

FIG. 1 is a schematic diagram showing an electronic device according to an embodiment of the invention. An electronic device 100 includes a touch pad 110 and a control processor 120. The control processor 120 is electronically connected to the touch pad 110. The voltage or current is changed due to the touch on the touch pad 11, the touch pad 110 transmits the signal (the change of voltage or current) to the control processor 120, the control processor 120 further determine the change of voltage or current to confirm the corresponding command according to stored setting values such as a reference value or a reference time, and then the control processor 120 transmits the corresponding control signal to the electronic device to execute or display the command of a user. The control processor 120 may be a central processing unit (CPU) of a notebook and corresponding storages or a chip with a processor and corresponding storages.

In the embodiment, the touch pad 110 includes a first touch zone 112 and a second touch zone 114. The first touch zone 112 includes a first rectangle 112a and a second rectangle 112b. The second touch zone 114 is a third rectangle 114a located at a side of the first rectangle 112a. The shape and the size of the first touch zone 112 and the second touch zone 114 is not limited herein.

FIG. 2 is a schematic diagram showing the influence on the detecting circuit due to the touch on the touch pad in FIG. 1. When the touch pad 110 receives a touch, a first pressure is generated on the touch pad 110. The first pressure is applied at a first area 116a. At a detecting circuit corresponding to the touch pad 110, such as the distribution of capacitance induction energy, most of the value higher than a standard value is between area a and area b. When a user wants to execute a function like moving a mouse, he or she can slide a finger on the touch pad 110. Since the pressure is maintained at the first pressure or slightly changed or the finger is far out of the first area 116a in sliding the finger, the control processor 120 continually generates the control signal correspondingly according to the moving state to display the position of the cursor at a display of the electronic device 100.

When the user wants to execute the function of clicking a mouse left or right key of the electronic device 100, the user can press the touch pad 110 at the original first area 116a to generate a second pressure, since the second pressure is larger than the first pressure, the influence area on the touch pad 110 is improved from the first area 116a to the second area 116b. As shown in FIG. 2, the distribution of induction energy is changed, for example, most of the value higher than a standard value is improved to be between area c and area d from between area a and area b. Consequently, the control processor 120 can determine the corresponding command to generate a corresponding control signal such as a confirmed click signal according to the change of the distribution.

Additionally, since induction energy distribution of electric signals detected on the touch pad 110 are arranged likes contour lines, electric signals are different at areas touched and untouched by the finger, and the value of pressure also can affect the induction energy distribution of the area adjacent to the finger touch area, and thus the control processor 120 can determine whether the increase value of the second pressure P2 at a touch range 116 is larger than a reference value so as to identify whether the touch is an effective click action. When the touch is confirmed to be an effective click action, the electronic device determines that the finger executes a press action, and it makes the control processor 120 generate a click signal to execute the function of clicking the mouse left key to execute the command or the function of clicking the right key to display menus.

The control processor 120 also may have a reference time. Except for determining whether the increase value of the second pressure at the touch range 11 is larger than the reference value, the control processor 120 also can determine whether the duration of the second pressure at the second area 116b is longer than a reference time set at the control processor 120 to further determine whether the touch is the effective click action. Other various kinds of methods also can be used for identifying whether the touch is the effective click action, which is not limited herein.

Furthermore, the click signal generated by the touch at the first touch zone 112 is a first signal, and the click signal generated by the touch at the second touch zone 114 is a second signal. The first signal and the second signal are used for executing different functions. In this embodiment, the first signal is used for executing the function of the mouse left key, and the second signal is used for executing the function of the mouse right key. Whether the user executes the function of the mouse left or right key is according to the position of the touch on the touch pad 110. In this embodiment, the function of the mouse left key not only can be executed via the effective click action at bottom left of the touch pad 110, it also can be executed via the effective click at the whole the first touch zone 112.

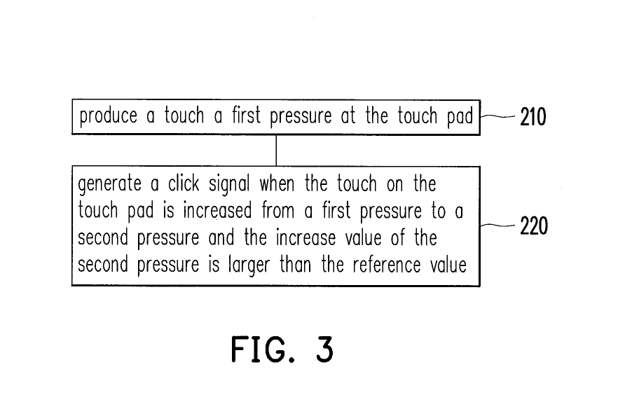

FIG. 3 is a flowchart showing a touch control method according to an embodiment of the invention. In the embodiment, the touch control method is adapted to an electronic device with a touch pad. The electronic device further includes a control processor except for the touch pad. The touch pad is electronically connected to the control processor and has a reference value.

First, at step S210, a user touches the touch pad with a first pressure. When the pressure of the touch on the touch pad is increased from the first pressure to the second pressure, and the increase value of the second pressure is larger than the reference value, the control processor determines that the touch is an effective click action and generates a click signal (step 220) to execute the function of the left key or the right key to confirm the command. If the increase value of the second pressure is not larger than the reference value, the command may be another different command, such as a command to move the cursor. Additionally, to further improve the accuracy, the method may further include a step for determining whether the duration of the second pressure at the touch pad is longer than the reference time at the control processor to confirm whether the touch is the effective click action.

In the embodiment, if the touch is the first pressure at the touch pad, the control processor generates a control signal, and the control signal may be used for controlling the position of the cursor displayed at the display. When the touch is increased from the first pressure to the second pressure, the control processor starts to determine whether the touch is an effective click action. Additionally, the click signal generated by the touch at the first touch zone is a first signal, and the click signal generated by the touch at the second touch zone is a second signal, and the first signal and the second signal are used for executing different functions. For example, the first signal is used for executing the function of the mouse left key, and the second signal is used for executing the function of the mouse right key, and the function to be executed is identify according to the position of the touch at the touch pad.

To sum up, according to the change of the pressure at the touch pad and the duration of the pressure, the electronic device and the touch control method in embodiments can determine whether the touch is an effective click action so as generate the click signal. As a result, a user can execute the function of the mouse left key and the mouse right key by controlling the force touching on the touch pad, which is quite convenient in operation.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, comprising:
a touch pad for receiving a touch; and
a control processor electronically connected to the touch pad and having a reference value;
wherein when the touch on the touch pad is increased from a first pressure to a second pressure, if the control processor determines the increase value of the second pressure is larger than the reference value, the control processor generates a click signal.

2. The electronic device according to claim 1, wherein the control processor has a reference time, when duration of the second pressure is longer than the reference time, the control processor generates the click signal.

3. The electronic device according to claim 1, wherein when the first pressure is applied on the touch pad, the control processor generates a control signal.

4. The electronic device according to claim 1, wherein the touch pad includes a first touch zone and a second touch zone, the click signal generated by the touch at the first touch zone is a first signal, the click signal generated by the touch at the second touch zone is a second signal, and the first signal and the second signal are used for executing different functions.

5. The electronic device according to claim 4, wherein the first touch zone includes a first rectangle and a second rectangle, the second touch zone is a third rectangle, and the second rectangle and the third rectangle are located at a side of the first rectangle.

6. A touch control method, adapted for an electronic device, wherein the electronic device includes a touch pad and a control processor, the touch pad is electronically connected to the control processor, the control processor has a reference value, the touch control method comprising:
producing a touch a first pressure at the touch pad; and
generating a click signal when the touch on the touch pad is increased from a first pressure to a second pressure and the increase value of the second pressure is larger than the reference value.

7. The electronic device according to claim 6, wherein the touch control method further includes determining that duration of the second pressure is longer than the reference time set at the control processor before generating the click signal.

8. The electronic device according to claim 6, wherein the control processor generates a control signal when the first pressure is applied at the touch pad.

9. The electronic device according to claim 6, wherein the touch pad includes a first touch zone and a second touch zone, the click signal generated by the touch at the first touch zone is a first signal, the click signal generated by the touch at the second touch zone is a second signal, and the first signal and the second signal are used for executing different functions.

10. The electronic device according to claim 9, wherein the first touch zone includes a first rectangle and a second rectangle, the second touch zone is a third rectangle, and the second rectangle and the third rectangle are located at a side of the first rectangle.
